(19) United States
(12) Patent Application Publication
(10) Pub. No.: US 2009/0202839 A1
(43) Pub. Date: Aug. 13, 2009

(54) ADHESIVE AND LAMINATE FOR PACKAGING USING THE SAME

(75) Inventors: Minoru Uno, Tokyo (JP); Yoshihiro Sato, Tokyo (JP); Wataru Koshimizu, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignees: Toyo Ink Mfg. Co., Ltd., Chuo-ku (JP); Toyo Morton, Ltd., Chuo-ku (JP)

(21) Appl. No.: 11/912,898

(22) PCT Filed: Oct. 6, 2005
(86) PCT No.: PCT/JP2005/018544

§ 371 Date: Jun. 27, 2008

(30) Foreign Application Priority Data
Apr. 28, 2005 (JP) 2005-132910

(51) Int. Cl. B32B 27/36; C08G 63/02; C08G 63/91

(52) U.S. Cl. 428/423.1; 525/440.01; 525/419

(57) ABSTRACT

Provided is an adhesive giving a laminate for packaging that favorably withstands retort processing even when the period for curing reaction (aging period) is shortened. The adhesive conysind: a partially acid-modified polyester alcohol composition (A), prepared by esterifying a part of the hydroxyl groups in a polyester alcohol composition produced by condensation of a polyvalent alcohol and a polyvalent alcohol containing at least one of a monocarboxylic acid and a monovalent alcohol, with anhydrotrimellitic acid and a anhydrotrimellitate ester at an anhydrotrimellitic acid/anhydrotrimellitate ester ratio of 10/90 to 70/30 (by mass); and a polyisocyanate (B). Also provided is a laminate for packaging of a plurality of sheet-shaped base materials bonded to each other with the adhesive.

### TECHNICAL FIELD

The present invention relates to a urethane-based adhesive favorably used in laminating various plastic films, metal foils or metallized films, and a laminate for packaging using the same. More specifically, it relates to a urethane-based adhesive prepared from a particular alcoholic compound by modification of polyester polyol, and a polyisocyanate (B), and to a laminate for packaging, prepared by using the same and favorably used in soft-packaging of, e.g., foods, medicines, cosmetics and the like (hereinafter referred to as foods and others).

### BACKGROUND ART

Conventionally, multilayered composite films of a plastic film of polyethylene, polypropylene, nylon, polyester or the like laminated with a metal foil such as aluminum foil or a metallized film have been used widely as materials for packaging foods, medicines, cosmetics and others (hereinafter, referred to as packaging materials). Urethane-based adhesives in combination of a polyol component and an isocyanate component have been known as the adhesives for bonding such a plastic film with a metal foil or a metallized film.

Recently, adhesives improved in adhesiveness are provided as adhesives for packaging materials for foods containing free fatty acid and the like. For example provided is an adhesive containing a urethane-modified polyester polyol obtained by urethane modification of a polyester polyol, instead of a polyol component for conventional urethane-based adhesives.

In addition, there are many proposals for modification of the urethane-based adhesive.

Proposed are, for example: a blend of a urethane-based adhesive with a phosphorus oxyacid or the derivative thereof, an epoxy resin, a silane-coupling agent, etc.; a compound using a polyester obtained by allowing a polyvalent carboxylic anhydride to react with a polyester having two or more terminal hydroxyl groups and thus carboxylating at least one terminal thereof, as the polyol component for the urethane-based adhesive (see Japanese Patent Application Laid-Open No. 60-243182); and a blend that a polybasic acid anhydride containing at least two acid anhydride groups in the molecule is blended with a urethane-based adhesive.

Most of conventional adhesives for use with laminate for packaging are so-called two-part adhesives that are used by mixing a major agent and a hardening agent (crosslinking agent). Such a two-part adhesive, after mixing a major agent and a hardening agent (crosslinking agent) is applied on a sheet-shaped base material (e.g., plastic film, metal foil, metallized film, etc.) for packaging material, and the solvent is dried as needed; and then, the other sheet-shaped base material (e.g., metal foil, metallized film, or plastic film) is superimposed and bonded to the adhesive layer. In order to proceed the reaction between the major agent and the hardening agent (crosslinking agent), the mixture should be aged as the adhesive layer in the superimposed state, and the aging period varies according to the requirement demanded in application of the laminate.

Specifically, when the content is a light and dry substance such as dry food or snack food, or when the temperature of hot-water sterilization after packaging of the content is 100 degrees C. or lower, the aging period is usually one to two days at 20 to 40 degrees C. In contrast, when the film is to be subjected to retort processing in hot water or steam at a temperature of 120 degrees C. or higher for sterilization after packaging of the content, an aging period of about 4 to 5 days at 40 to 60 degrees C. is necessitated currently for reaction of the major agent and the hardening agent (crosslinking agent) in the adhesive layer, for assuring favorable preservation of the heat resistance during retorting and prevention of deterioration in adhesiveness during long-term storage after retorting (see Japanese Patent Application Laid-Open No. 60-243182).

However, there is recently a need for shortening of the aging period and thus improvement in productivity, for production of small batches of many different products and also for shortening of the delivery period, but simple shortening of the aging period only results in deterioration in heat resistance, prohibiting preservation of the adhesiveness during long-term storage. For that reason, there is an urgent need for an adhesive that provides a laminate for packaging, in particular that in retort application, with sufficient adhesiveness and allows shortening of the aging period.

### DISCLOSURE OF THE INVENTION

An object of the present invention is to provide an adhesive that gives a laminate withstanding retort processing even when the period for curing reaction (curing period) is shortened and resistant to deterioration in adhesiveness during long-term storage, and a laminate for packaging prepared by using the same.

After intensive studies to solve the problems above, the inventors have found that it is possible to obtain a packaging laminate superior in hot water resistance, acid resistance and oil resistance even when aged only for a short period, by using a polyester-based adhesive containing a partially acid-modified polyester alcohol obtained by partial modification of a particular polyester alcohol with an acid, and a polyisocyanate, and have completed the present invention.

According to one aspect of the present invention, an adhesive comprises: a partially acid-modified polyester alcohol composition (A) prepared by esterifying a part of the hydroxyl groups in a polyester alcohol composition (AA) produced by condensation of a polyvalent alcohol and a polyvalent carboxylic acid containing at least one of a monocarboxylic acid and a monovalent alcohol, with anhydrotrimellitic acid and an anhydrotrimellitate ester at an anhydrotrimellitic acid/anhydrotrimellitate ester ratio of 10/90 to 70/30 (by mass); and a polyisocyanate (B).

According to another aspect of the present invention, an adhesive comprises: a polyester alcohol composition (A) containing hydroxyl groups, ester groups of a hydroxyl or carboxyl group esterified with a monocarboxylic acid or a monovalent alcohol, first acyloxy groups formed in reaction of a hydroxyl group with anhydrotrimellitic acid, and second acyloxy groups formed in reaction of a hydroxyl group with an anhydrotrimellitate ester, wherein the ratio of the first acyloxy groups to the second acyloxy groups corresponds to such a molar ratio of anhydrotrimellitic acid to the anhydrotrimellitate ester that the ratio by mass of anhydrotrimellitic acid to the anhydrotrimellitate ester is 10/90 to 70/30; and a polyisocyanate (B).

According to one aspect of the present invention, a laminate for packaging comprises a plurality of sheet-shaped base materials laminated with the adhesive above.

### BEST MODE FOR CARRYING OUT THE INVENTION

The applicant had proposed an adhesive for packaging laminate that is high in adhesive strength and resistant to deterioration in strength and generation of pinhole over time, in an earlier patent application (Japanese Patent Application No. 2003-368566). However, there was a need for shortening the period for curing reaction of the adhesive in production of the laminate, and thus, conducted was a study aimed at improving the adhesive for retention of its high adhesiveness even when the curing period is shortened. As a result, the inventors have found that, when a polyester alcohol (AA) containing a polyester monoalcohol having a part of the hydroxyl groups at the polyester terminals being sealed with a monofunctional component is prepared by blending the monofunctional component (monovalent alcohol or monocarboxylic acid) with at least one of the acid component and the hydroxyl component used in production of polyester polyols, and a part of the hydroxyl groups thereof is acid-modified to give a partially acid-modified polyester alcohol (A), this acid-modified polyester alcohol (A) at the use hardens favorably in reaction with a polyisocyanate, giving a product maintained high in adhesiveness even when the curing period is shortened.

Thus, the main component for the adhesive according to the present invention is the partially acid-modified polyester alcohol (A). And, the adhesive is constructed by combining this partially acid-modified polyester alcohol (A) with polyisocyanate (B) as a hardening agent.

The partially acid-modified polyester alcohol (A) is prepared by acid modification (esterification) of a part of the hydroxyl groups of the polyester alcohol (AA) with anhydrotrimellitic acid and an anhydrotrimellitate ester.

The polyester alcohol (AA) is polyester obtained by substitution of a part of at least one of a polyvalent alcohol and a polycarboxylic acid (raw materials for polyester polyol) with a monofunctional component (monovalent alcohol or monocarboxylic acid), and condensation reaction thereof, and it is a polymer composition containing a polyester polyol and a polyester monoalcohol. If the polyester alcohol (AA) is prepared by using a dicarboxylic acid and a glycol as the polycarboxylic acid and the polyvalent alcohol, the resulting composition contains a polyester monoalcohol terminally sealed with a monofunctional component at one terminal of the polyester molecule and a polyester dialcohol unsealed, and the average hydroxyl group number in one molecule of the polyester alcohol (AA) becomes less than two.

The partially acid-modified polyester alcohol (A) is a polymer composition prepared by using such a polyester alcohol (AA) as the raw material. Each molecule has a structure that contains a polyester chain, and one group bounds to each terminal of the polyester chain, of: a hydroxyl group; two kinds of acid-modified acyloxy groups; and residual groups bound through ester bond that are derived from monofunctional components used for terminal sealing. The partially acid-modified polyester alcohol (A) has a suitable amount of the terminal blocked unit therein. As a result, in the adhesive according to the present invention, polymerization between the partially acid-modified polyester alcohol (A) and the polyisocyanate (B) does not become excessive and it is cured in a shorter period of time.

The polyester alcohol (AA) will be described first.

The polyester alcohol (AA) is obtained by blending a monofunctional component with a multifunctional carboxylic acid and a multifunctional alcohol, and by allowing the mixture to esterify in dehydration condensation according to a common method. In the present invention, it is important that at least one of the carboxylic acid component and the alcohol component contains the monofunctional component. If a polyester polyol containing no monofunctional component is used in partial acid modification, it is difficult to shorten the curing period for curing reaction of the partially acid-modified polyol obtained thereby with the hardening agent polyisocyanate (B).

The monofunctional component for use in the present invention is a monovalent compound, that is, a monocarboxylic acid and/or a monovalent alcohol. The monovalent compound is not particularly limited, but a compound having a boiling point higher than the esterification reaction temperature is preferably used so that it can condensate under general esterification condition. If the monofunctional component is a monocarboxylic acid, the monocarboxylic acid reacts in esterification with a part of the terminal hydroxyl groups of the polyester polyol, forming monocarboxylic acid-derived residues at the terminal. If the monofunctional component is a monovalent alcohol, the monovalent alcohol reacts in esterification with a part of the terminal carboxylic acid groups of the polyester polycarboxylic acid, forming monovalent alcohol-derived residues at the terminals. Examples of the monocarboxylic acids include octylic acid, stearic acid, benzoic acid, t-butylbenzoic acid and the like. Examples of the monovalent alcohols include octyl alcohol, stearyl alcohol and the like. The monocarboxylic acids and the monovalent alcohols may be used alone or in combination of two or more.

Examples of the polycarboxylic acids for the polyester alcohol (AA) used in combination with the monofunctional component include dibasic acids such as terephthalic acid, isophthalic acid, adipic acid, azelaic acid and sebacic acid; the dialkyl esters thereof; mixtures of a dibasic acid and a dialkyl ester of dibasic acid, and these acids may be used alone or in combination of two or more.

Examples of the polyvalent alcohols to be used in combination with the monofunctional component for preparing the polyester alcohol (AA) include glycols such as ethylene glycol, propylene glycol, diethylene glycol, butylene glycol, neopentylglycol, 1,6-hexanediol, 3-methyl-1,5-pentanediol, 3,3′-dimethylol heptane, polyoxyethylene glycol, polyoxypropylene glycol, polytetramethylene ether glycol and the like, and these alcohols may be used alone or in combination of two or more. Alternatively, a lactone such as polycaprolactone, polyvalerolactone, poly(β-methyl-γ-valerolactone) and the like may be used. In this case, the polyester polyol is obtained by ring-opening polymerization with use of a polyvalent alcohol at one terminal, and a monocarboxylic acid may be used as the monofunctional component.

When the monofunctional component is a monocarboxylic acid, the ratio of the monocarboxylic acid in the acid components for the polyester alcohol (AA) is preferably 10 mol % or less. When the monofunctional component is a monovalent alcohol, the ratio of the monovalent alcohol in the hydroxyl components for the polyester polyol (AA) is preferably 10 mol % or less. In any case, the ratio is more preferably in the range of 0.5 to 2 mol %, and most preferably in the range of 0.7 to 1.5 mol %.

In preparation of the polyester alcohol (AA), the hydroxyl components are favorably present in an amount greater than that of the acid components, and specifically, the ratio is preferably, approximately 1.1 to 1.2. Accordingly, when a monocarboxylic acid and a monovalent alcohol are used in combination, the total of the monocarboxylic acid and the monovalent alcohol (total monofunctional components) is preferably at a ratio of 0.5 to 12 moles with respect to 100 moles of the acid components and 110 to 120 moles of the hydroxyl components (total 210 to 220 moles). A monofunctional component ratio of less than 0.5 moles almost prohibits the terminal-blocking effect by the monofunctional component. On the other hand, addition of the monofunctional components in excess leads to lack of the number of hydroxyl groups, i.e. reaction points with the polyisocyanate (B), in the partially acid-modified polyester alcohol prepared by modification of the obtained polyester alcohol with anhydrotrimellitic acid, etc., thus to significant decrease in the degree of crosslinking, and consequently to insufficient adhesiveness even after curing for an extended period of time.

When the polycarboxylic acid and the polyvalent alcohol containing the monofunctional component at the ratio described above are allowed to react while the alcohol component content is in excess to the acid component content, for example at a ratio of preferably 1.1 to 1.2, the excess amount of the alcohol component remains in the reaction product. Thus the polyester alcohol (AA) is obtained by vaporization of the alcohol component remained after the reaction. Then, the ratio of the monovalent alcohol added to the raw material alcohol component agrees roughly with the ratio of the monovalent alcohol in all of the alcohol components for the polyester alcohol (AA).

If a urethane-modified polyester alcohol (Aa) that is obtained through additional urethane modification is used as the polyester alcohol (AA) for production of the partially acid-modified polyester alcohol (A), the cohesive force of the adhesive is improved and it is thus effective in improving heat resistance and content resistance.

The number-average molecular weight of the urethane-modified polyester polyol (Aa) is preferably 3500 to 19000, more preferably 4500 to 15000.

Alternatively, the hydroxyl value of the urethane-modified polyester polyol (Aa) is preferably 5 to 25 (mgKOH/g), more preferably 7 to 20 (mgKOH/g).

The average number of the OH groups in the molecule of the urethane-modified polyester alcohol (Aa) is preferably 1.5 or more than 1.5 and less than 2, more preferably, approximately 1.6 to 1.8.

The urethane-modified polyester alcohol (Aa) is obtained by allowing a polyester alcohol (Aaa) prepared similarly to the above-described polyester alcohol (AA) to react with a polyisocyanate (Aab) under a hydroxyl-group-excessive condition.

The polyester alcohol (Aaa) used in the case above is preferably a polyester alcohol having a number-average molecular weight of 3000 to 15000, more preferably having a number-average molecular weight of 4000 to 12000. The polyester alcohol (Aaa) is preferably a polyester alcohol having a hydroxyl value (OHV) of 5 to 30 mgKOH/g, more preferably having a hydroxyl value of approximately 7 to 25 mgKOH/g. The average number of hydroxyl groups in a molecule of the polyester alcohol (Aaa) is preferably 1.3 or more than 1.3 and less than 2, more preferably approximately 1.65 to 1.85. With use of such a polyester alcohol (Aaa), it is possible to prepare a favorable urethane-modified polyester alcohol (Aa).

Here, it is noted that the average number of the hydroxyl groups in the molecule of the polyester alcohol may be calculated from the number-averaged molecular weight Mn and the hydroxyl value [mgKOH/g] determined by measurement in accordance with the following formula (as the molecular weight of KOH is 56.1).

Average number of hydroxyl groups in molecule=(Hydroxyl value×Mn)/56100

The hydroxyl value may be determined, for example, by measurement of a sample according to the following procedures (1) to (6), and this method is also applicable to the polyester alcohols (A, AA, Aa and Aaa) according to the present invention.

(1) The mass S¹ (g) of a sample (approximately 5 to 8 g) is weighed accurately; 25 ml of a pyridine solution of phthalic anhydride (14 w/v %) is added to the sample; the mixture is heated in a water bath at 98 degrees C. for two hours while stirred occasionally, allowing esterification of the hydroxyl group in the sample with phthalic anhydride to produce a monobasic acid. At the same time, phthalic anhydride that does not react with the sample is hydrolyzed and splited with pyridine, giving a dibasic phthalic acid. Accordingly, increase in the number of hydroxyl groups in the sample leads to decrease in the amount of dibasic acid or phthalic acid given from phthalic anhydride and increase in the amount of monobasic acid, and thus, to decrease in the total carboxyl group amount.

(2) The sample is then cooled to room temperature; a pyridine solution of phenol phthalein (1 w/v %) is added thereto as an indicator; the mixture is titrated with 0.5 N aqueous sodium hydroxide solution until the end point when the solution remains red in color at least for 15 seconds; and the titer A (ml) of the 0.5 N aqueous sodium hydroxide solution necessary for reaching the end point is determined. The titer A (ml) is a volume needed for neutralization of the carboxyl groups of the sample, the carboxyl groups of the reaction product (monobasic acid) between the hydroxyl group of sample and phthalic anhydride, and the carboxyl groups of the phthalic acid (dibasic acid) produced by ring opening of phthalic anhydride.

(3) Separately, the titer B (ml) of 0.5 N aqueous sodium hydroxide solution necessary for neutralization titration of the carboxyl groups, i.e. phthalic carboxyl groups, contained in 25 ml of a pyridine solution of phthalic anhydride (14 w/v %) is determined.

(4) The apparent hydroxyl value H¹ of the sample [mgKOH/g] is calculated from the difference (B−A) between the titers A and B thus obtained, in accordance with the following formula (wherein, f: factor of 0.5 N aqueous sodium hydroxide). When the sample has carboxyl groups, the apparent hydroxyl value H¹ becomes smaller than its actual hydroxyl value by that for the carboxyl groups.

H¹=28.05×(B−A)×f/S¹

(5) Moreover, separately from the above, the mass S² (g) of another portion of sample (approximately 2 to 5 g) is weighed accurately; and the titer C (ml) of the 0.5 N aqueous sodium hydroxide solution necessary for neutralization of carboxyl groups in the sample is determined by using the 0.5 N aqueous sodium hydroxide solution described above. The amount of carboxyl groups, i.e. acid value H² (mgKOH/g), of the sample is calculated from the titer C in accordance with the following formula.

H²=28.05×C×f/S²

(6) The absolute hydroxyl value H of the sample is calculated from the apparent hydroxyl value H¹ and the acid value H² of the sample in accordance with the following formula.

H=H¹+H²

Hereinafter, the polyisocyanate (Aab) used in preparation of the urethane-modified polyester polyol will be described.

Examples of the polyisocyanates (Aab) used in urethane modification include aliphatic diisocyanates, alicyclic diisocyanates, aromatic diisocyanates, araliphatic diisocyanates; trifunctional or higher-functional polyisocyanate monomers; dimers, trimers, allophanamides and allophanates derived from the diisocyanates above; polyisocyanates having a 2,4,6-oxadiazine trione ring obtained from carbon dioxide gas and the diisocyanate above; and the like.

Examples of the aliphatic diisocyanates include trimethylene diisocyanate, tetramethylene diisocyanate, hexamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate, 2,6-diisocyanatomethyl caproate, and the like.

Examples of the alicyclic diisocyanates include 1,4-cyclohexane diisocyanate, 1,3-cyclohexane diisocyanate, 3-isocyanatomethyl-3,5,5-trimethylcyclohexyl isocyanate, 4,4′-methylene-bis(cyclohexyl isocyanate), methyl-2,4-cyclohexane diisocyanate, methyl-2,6-cyclohexane diisocyanate, 1,4-bis(isocyanatomethyl)cyclohexane, 1,3-bis(isocyanatomethyl)cyclohexane, and the like.

Examples of the aromatic diisocyanates include m-phenylene diisocyanate, p-phenylene diisocyanate, 4,4′-diphenyl diisocyanate, 1,5-naphthalene diisocyanate, 4,4′-diphenylmethane diisocyanate, 2,4- or 2,6-tolylene diisocyanate or the mixture thereof, 4,4′-toluidine diisocyanate, dianisidine diisocyanate, 4,4′-diphenyl ether diisocyanate, and the like.

Examples of the araliphatic diisocyanates include 1,3- or 1,4-xylylene diisocyanate or the mixture thereof, ω,ω′-diisocyanate-1,4-diethylbenzene, 1,3- or 1,4-bis(1-isocyanate-1-methylethyl)benzene or the mixtures thereof, and the like.

Examples of the trifunctional or higher-functional polyisocyanate monomers include triisocyanates such as triphenylmethane-4,4′,4″-triisocyanate, 1,3,5-triisocyanatebenzene and 2,4,6-triisocyanatotoluene; tetraisocyanates such as 4,4′-diphenyldimethylmethane-2,2′,5,5′-tetraisocyanate, and the like.

Examples of the trifunctional or higher-functional polyisocyanates include adducts of the diisocyanate with a low-molecular weight polyol having a molecular weight of less than 200 such as ethylene glycol, propylene glycol, butylene glycol, hexylene glycol, neopentylglycol, 1,6-hexanediol, 3-methyl-1,5-pentanediol, 3,3′-dimethylolpropane, cyclohexanedimethanol, diethylene glycol, triethylene glycol, dipropylene glycol, glycerol, trimethylolpropane, pentaerythritol and sorbitol; and adducts of polyester polyol, polyether ester polyol, polyester amide polyol, polycaprolactone polyol, polyvalerolactone polyol, acrylpolyol, polycarbonate polyol, polyhydroxyalkane, castor oil, polyurethane polyol or the like having a molecular weight of 200 to 20,000.

The urethane modification, i.e. the reaction between the polyester alcohol (Aaa) and the polyisocyanate (Aab), is preferably carried out at 200 degrees C. or lower, more preferably in a temperature range of 120 to 180 degrees C. The polyester alcohol (Aaa) and the polyisocyanate (Aab) are preferably allowed to react with each other at such a ratio that the amount of isocyanate group of the polyisocyanate (Aab) is 0.5 times or less by equivalence ratio with respect to that of the hydroxyl group of the polyester alcohol (Aaa), more preferably 0.1 to 0.3 times, and still more preferably 0.15 to 0.2 times by equivalence ratio.

Hereinafter, “partial acid modification” of the polyester alcohol will be described.

The partially acid-modified polyol (A), the main component for the adhesive according to the present invention, is obtained by allowing a part of the hydroxyl groups in the polyester alcohol (AA or Aa) described above to react with anhydrotrimellitic acid and anhydrotrimellitate ester, and the acid ratio of anhydrotrimellitic acid/anhydrotrimellitate ester is 10/90 to 70/30 (by mass). Corresponding to the molar ratio of the acids used at the above ratio, produced are acyloxy groups given from anhydrotrimellitic acid reacting with hydroxyl groups, and another acyloxy groups given from the anhydrotrimellitate ester with hydroxyl group.

The modification ratio of the partially acid-modified polyol (A) obtained by partial acid modification, i.e., the ratio of the hydroxyl groups reacting with anhydrotrimellitic acid or the anhydrotrimellitate ester to give esters (acid-modified) in those of the above-described polyester alcohols (AA or Aa) is preferably 20 to 90%, more preferably 25 to 40%. The modification ratio [%] is a value that is relative to the average number of hydroxyl groups in molecule before partial acid modification, which is calculated according to the following formula.

Modification ratio (%)=[(Hydroxyl group number before modification−Hydroxyl group number after modification)/Hydroxyl group number before modification]×100

A modification ratio of less than 20% results in insufficient improvement in the content resistance of the adhesive. Alternatively, addition of said two kinds of acid anhydrides to the polyester alcohol (AA or Aa) at a modification ratio exceeding 90% often, unfavorably leads to easier remaining of unreacted anhydrotrimellitic acid and anhydrotrimellitate ester, as suspended in the partially acid-modified polyol, and consequently to deterioration in physical properties, for example in adhesiveness to the laminate base material.

The anhydrotrimellitate ester for use in the present invention is an ester compound obtained by esterifying an alkylene glycol or alkane triol having 2 to 30 carbon atoms with anhydrotrimellitic acid. Excessive elongation of the alkylene glycol chain often leads to decrease in density of the polar groups (urethane or ester bond) and thus easily to decrease in adhesiveness of the adhesive. Use of an alkane triol may leads to drastic increase in viscosity and also in the possibility of gelling during production, and thus, ethylene glycol bisanhydrotrimellitate represented by the following formula (I) is preferable.

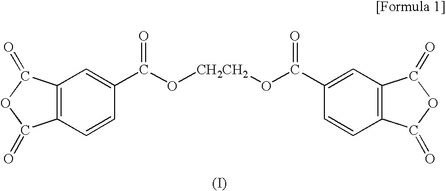

As for the ratio of anhydrotrimellitic acid and anhydrotrimellitate ester for use in partial acid modification, it is important that the ratio of anhydrotrimellitic acid is 10 to 70 mass % and the ratio of the anhydrotrimellitate ester is 90 to 30 mass %. Preferably, they are reacted at a ratio of anhydrotrimellitic acid/anhydrotrimellitate ester being in the range of 10/90 to 50/50 (by mass).

When the anhydrotrimellitic acid ratio is less than 10 mass % (unhydrotrimellitate ester is more than 90 masse), or when the anhydrotrimellitic acid ratio is more than 70 mass % (unhydrotrimellitate ester is less than 30 mass %), the resulting adhesive possibly gives a composite film having an adhesive strength similar to that given when the anhydrotrimellitic acid ratio is 10 to 70 mass %, just before and after the retort processing. However, the adhesive strength of the adhesive layer after the retort processing gradually declines with time under influence of the packed content.

The reaction of the polyester alcohol with anhydrotrimellitic acid and the anhydrotrimellitate ester is preferably carried out at a reaction temperature controlled to 200 degrees C. or lower, more preferably in the range of 150 to 180 degrees C., so that the esterification by ring opening of anhydrotrimellitic acid and anhydrotrimellitate ester is made to the major reaction.

A smaller number-average molecular weight and a larger hydroxyl value of the partially acid-modified polyol (A) means that the average number of hydroxyl groups in the molecule is larger. In such a case, it is difficult to shorten the curing period needed for curing of the adhesive in combination with the hardening agent. Moreover, the crosslinked structure is denser after reaction with the hardening agent, and the adhesive layer becomes more rigid. Thus, such adhesive layer may become less adhesive to a soft film (e.g. polypropylene) or a film easily expanding/shrinking under influence of moisture (e.g. nylon) in the laminated structure.

On the other hand, a larger number-average molecular weight and a smaller hydroxyl value of the partially acid-modified polyol (A) leads to a smaller average number of hydroxyl groups in the molecule. In this case, the crosslinked structure after reaction with a hardening agent becomes rather coarse, and the adhesive layer becomes more flexible, causing concerns about insufficient heat resistance and the like.

From the viewpoints above, the average number of hydroxyl groups in the molecule of partially acid-modified polyester alcohol (A) is preferably 1.005 to 1.6, more preferably approximately 1.05 to 1.3.

Moreover, increase in the number-average molecular weight of the partially acid-modified polyol (A) as the main component for the adhesive leads to increase in viscosity of the adhesive, that may make it difficult to apply the adhesive uniformly on a sheet-shaped base material described below. Accordingly, for uniform application of the adhesive, the number-average molecular weight of the partially acid-modified polyol (A) is preferably controlled to an appropriate value being not too large, so that the viscosity of the adhesive becomes favorable. The adhesive according to the present invention is suitably used in the form of organic solvent solution. In this mode of use, if its viscosity is so high that it is difficult to apply the adhesive in the use mode, the solution may be diluted with an increased amount of organic solvent for reduction in viscosity. In this way, it is also possible to use a partially acid-modified polyol (A) having a large number-average molecular weight. However, use of a large amount of organic solvent makes it difficult to dry the adhesive and remove the solvent from it after application, and is thus unfavorable.

In view of the above, the number-average molecular weight of the partially acid-modified polyester alcohol (A) is preferably 4000 to 20000, more preferably 5000 to 18000. Here, it is noted that the number-average molecular weight described according to the present invention is a value reduced for polystyrene standard, as determined by GPC (gel permeation chromatography).

Taking into consideration the average hydroxyl-group number per molecule and the number-average molecular weight described above, the hydroxyl value of the partially acid-modified polyester alcohol (A) is preferably 3 to 15 mgKOH/g, more preferably 3.5 to 12 mgKOH/g.

Alternatively, it is also possibly regarded, if the hydroxyl value is expressed by the hydroxyl group amount per mass, as that the molar amount of the hydroxyl groups in 100 g of the partially acid-modified polyester alcohol (A) is preferably approximately 0.003 to 0.025 mole, more preferably approximately 0.005 to 0.017 mole.

The polyisocyanate (B), another component for the adhesive according to the present invention, is a compound generally called a hardening or crosslinking agent. Examples thereof include those exemplified for the polyisocyanates (Aab) used in preparation of the urethane-modified polyester alcohol (Aa) described above.

In the adhesive according to the present invention, the ratio of the polyisocyanate (B) to the partially acid-modified polyester alcohol (A) is preferably 5 to 50 parts by mass/100 parts by mass, more preferably 20 to 40 parts by mass/100 parts by mass. Alternatively, from the viewpoint of reactivity, such a combination at such a ratio that the number of isocyanate groups of the polyisocyanate (B) per 1 hydroxyl group of the partially acid-modified polyester alcohol (A) is 1.5 to 17 is preferable; a combination at a ratio of 3 to 15 isocyanate groups per 1 hydroxyl group is more preferable; and a combination at a ratio of 5 to 10 isocyanate groups per 1 hydroxyl group is still more preferable.

An excessively smaller blending ratio of the polyisocyanate (B) leads to decrease in the number of the crosslinking points formed in the adhesive, and it makes insufficient the heat resistance during the retort processing, likely causing separation or whitening in appearance after retort processing. The adhesiveness may also decline during long-term storage after retort processing. On the other hand, an excessive amount of isocyanate groups leads to residual of the excess isocyanate groups remaining unreacted, necessitating an elongated period for their disappearance, and also to excessive densification of the crosslinked structure, making the adhesive layer more rigid. Thus, such an adhesive layer may become less adhesiveness to a soft film (e.g. polypropylene) or to a film easily expanding/shrinking under influence of moisture (e.g. nylon) in the laminated structure.

Here, it is noted that the ratio of the hydroxyl group number X¹ to the isocyanate group number X² as described above is determined as follows.

The number of the hydroxyl groups X¹ in a partially acid-modified polyester alcohol (A) at a mass of w¹ (g) is determined from the average hydroxyl group number h in the molecule of the partially acid-modified polyester alcohol (A) and the number-averaged molecular weight Mn thereof, in accordance with the following formula. In addition, the number of NCO groups X² in the mass w² (g) of polyisocyanate (B) blended is determined from the molecular weight m of the polyisocyanate and the number n of functional groups in the polyisocyanate. Then the ratio of the isocyanate groups to the hydroxyl groups in the adhesive is calculated from these values.

X¹=(w¹/Mn)×h

X²=(w²/m)×n

Isocyanate group number/Hydroxyl group number of adhesive=X²/X¹

The adhesive according to the present invention, which contains the partially acid-modified polyester alcohol (A) and the polyisocyanate (B) as described above, may additionally contain a phosphorus oxyacid, the derivative thereof and/or a silane-coupling agent.

Among the phosphorus oxyacids and the derivatives thereof for use in the present invention, the phosphorus oxyacid is not particularly limited, if it has at least one free oxyacid, and examples thereof include phosphoric acids such as hypophosphorous acid, phosphorous acid, orthophosphoric acid, and diphosphoric acid; condensed phosphoric acids such as metaphosphoric acid, pyrophosphoric acid, tripolyphosphoric acid, polyphosphoric acid, ultraphosphoric acid and the like.

Examples of the derivative of the phosphorus oxyacids include partially esterified phosphorus oxyacids that the free oxyacids, excluding at least one oxyacid or more, of the above-described phosphorus oxyacid are esterified with an alcohol, and the like. Examples of the alcohols used in esterification include aliphatic alcohols such as methanol, ethanol, ethylene glycol, glycerol, etc.; aromatic alcohols such as phenol, xylenol, hydroquinone, catechol, fluoroglycinol, etc.; and the like.

The phosphorus oxyacids and the derivatives thereof may be used alone or in combination of two or more. The addition amount of the phosphorus oxyacids and the derivatives thereof is 0.01 to 10 parts by mass, preferably 0.05 to 5 parts by mass, more preferably 0.1 to 1 part by mass, with respect to 100 parts by mass of the partially acid-modified polyester alcohol (A).

The silane-coupling agent is not particularly limited, if it has a molecular structure represented by the following formula (II) or (III).

R—Si(X)₃ (II)

R—Si(R′)(X)₂ (III)

In the formulae (II) and (III), R represents an organic group having at least one group selected from vinyl, epoxy, amino, imino and mercapto groups; R′ represents a lower alkyl group; and X represents a methoxy or ethoxy group or a chlorine atom.

Examples of the silane-coupling agents include chlorosilanes such as vinyltrichlorosilane; aminosilanes such as N-(dimethoxymethylsilylpropyl)ethylenediamine and N-(trimethoxysilylpropyl)ethylenediamine; epoxysilanes such as γ-glycidoxypropyltrimethoxysilane and ≡-glycidoxypropyltriethoxysilane; vinylsilanes such as vinyltriethoxysilane; and the like. The addition amount of the silane-coupling agent is preferably 0.05 to 0.2 parts by mass with respect to 100 parts by mass of the partially acid-modified polyester alcohol (A).

Additives such as antioxidant, ultraviolet absorbent, hydrolysis inhibitor, fungicide, thickener, plasticizer, antifoam, pigment, filler and the like may be added as needed to the adhesive according to the present invention. In addition, a known catalyst, an additive and others may be used for adjustment of the curing reaction.

The adhesive according to the present invention, i.e. a mixture comprising a partially acid-modified polyester alcohol (A) and a polyisocyanate (B), is used favorably in the form of organic solvent solution. The amount of the nonvolatile matter, i.e. solid matter, in the organic solvent solution of the adhesive according to the present invention is preferably 40% or less, more preferably 20 wt % or more and less than 40%. When the amount of the nonvolatile matter is in the range above, it is possible to apply the solution on a sheet-shaped base material described below by using a common coating apparatus such as gravure coating machine.

The organic solvent used in the organic solvent solution of the adhesive according to the present invention may be any solvent if it is inert to the isocyanate, and examples thereof include esters such as ethyl acetate, ketones such as methylethylketone, aromatic hydrocarbons such as toluene and xylene, and the like.

The organic solvent solution of the adhesive according to the present invention is applied on the surface of a sheet-shaped base material described below by using a coating machine; after removal of the solvent by vaporization, another sheet-shaped base material is bonded to the adhesive face; and the composition is cured at normal temperature or under heat to give a laminate.

The organic solvent solution of the adhesive according to the present invention is preferably applied on the sheet-shaped base material in an adhesive coating amount after drying (hereinafter, referred to as adhesive coating amount) of 1 to 10 g/m², more preferably 2 to 5 g/m².

Hereinafter, the laminate for packaging that is formed by using the adhesive according to the present invention will be described.

The laminate for packaging comprises a plurality of sheet-shaped base materials laminated via adhesive layers of an adhesive.

The sheet-shaped base material is, for example, plastic film, paper, metal foil or the like commonly used for the laminate for packaging, and the sheet-shaped base materials laminated may be the same as or different from each other.

The plastic film used may be a film of a thermoplastic or thermosetting resin, but preferably a film of a thermoplastic resin. Examples of the thermoplastic resins include polyolefin, polyester, polyamide, polystyrene, polyvinyl chloride resins, vinyl acetate resins, ABS resins, acrylic resins, acetal resins, polycarbonate resins, cellulose type plastics and the like.

The thickness of the laminate for packaging is normally 10 μm or more. In the preparation of the laminate for packaging by using the adhesive solution according to the present invention, a commonly used method, for example, of: coating the adhesive solution on one surface of a sheet-shaped base material with a gravure coater; forming an adhesive layer by vaporization of the solvent; bonding another sheet-shaped base material thereto; and curing the composite at normal temperature or under heat, is possibly employed. The amount of the adhesive applied on the sheet-shaped base material surface is preferably approximately 1 to 10 g/m², more preferably 2.0 to 5.0 g/m².

The glass transition temperature (Tg) of the adhesive layer in the laminate for packaging according to the present invention is desirably in the range of −10 to 20 degrees C. A glass transition temperature of lower than −10 degrees C. may lead to insufficient heat resistance, resulting in remarkable deterioration in peeling strength after retort processing. On the other hand, a glass transition temperature of higher than 20 degrees C. may raise a concern about deterioration in the adhesiveness to soft base materials due to its hardness. An adhesive layer having a glass transition temperature of higher than 20 degrees C. is formed with a partially modified polyester alcohol higher in crystallinity. Since the partially modified polyester alcohol higher in crystallinity is generally more viscous, it makes the adhesive also highly viscous and may cause troubles such as difficulty in coating the adhesive uniformly on base material film. The glass transition temperature is possibly determined in a dynamic viscoelasticity test.

### EXAMPLES

Hereinafter, the present invention will be described more specifically with reference to Examples and Comparative Examples. The part and % in the Examples and Comparative Examples mean parts by mass and mass % respectively, unless specified otherwise.

### Preparative Example 1

### Preparation of Partially Acid-Modified Polyester Alcohol (A-1)

In a four-necked flask, placed were 20.5 parts of ethylene glycol, 45.8 parts of neopentylglycol, 38.9 parts of 1,6-hexanediol, 61.4 parts of isophthalic acid, 61.4 parts of terephthalic acid, 50.5 parts of sebacic acid and 1.2 parts of benzoic acid. The mixture was heated to 240 degrees C. while stirred under nitrogen stream for dehydration condensation, and the reaction was continued so that the acid value was reduced to 5 or less. Gradually decreasing the pressure to 1 mmHg, the reaction was further continued at that pressure for vaporization of excess alcohol, to give a polyester alcohol (Aaa-1) having a hydroxyl value of approximately 9 mgKOH/g and a number-average molecular weight of approximately 11000.

Stirring 300 g of the polyester alcohol (Aaa-1) under nitrogen stream, it was heated and 3 g of isophorone diisocyanate was added thereto in an atmosphere at 150 degrees C., and stirring of the mixture was continued. The reaction was continued until absorption derived from the unreacted NCO group disappeared in IR analysis, to give a urethane-modified polyester alcohol (Aa-1) having a hydroxyl value of approximately 7.5 mgKOH/g and a number-average molecular weight of approximately 12200.

In a four-necked flask, 300 g of the urethane-modified polyester alcohol (Aa-1) was placed and heated to 180 degrees C. while stirred under nitrogen stream. Then 4 g of ethylene glycol bisanhydrotritate and 2 g of anhydrotrimellitic acid were added thereto, and the mixture was kept at 180 degrees C. for 1 hour, allowing acid modification of 36% (calculated from blending ratio) of the hydroxyl groups in the urethane-modified polyester alcohol (Aa-1), to give a partially acid-modified polyester alcohol (A-1) having a hydroxyl value of approximately 5.1 mgKOH/g, a number-average molecular weight of approximately 12400, and an average hydroxyl group number per molecule of 1.13.

### Preparative Example 2

A partially acid-modified polyester alcohol (A-2) was obtained in the same manner as Preparative Example 1, except that the urethane modification was not performed.

### Preparative Examples 3 to 11

Partially acid-modified polyester alcohols (A-3) to (A-11) were obtained in the same manner as Preparative Example 1, except that the blending ratio of the raw materials used was changed respectively to the composition shown in Table 1 (values in Table: part by mass).

The average number of hydroxyl groups in the molecule of each of the polyester alcohols (Aaa-1 to 11), the urethane-modified polyester alcohols (Aa-1 to 11) and the partially acid-modified polyester alcohols (A1 to 11) was calculated from the number-average molecular weight and the hydroxyl value experimentally determined. Results are summarized in Table 1. From these values, it is possible to calculate the number of blocked end groups esterified to the monofunctional component, the number of urethane-modified end groups, and the average number of the acid-modified end groups in the molecule of each of the partially acid-modified polyester alcohols (A1 to 11). Each of partially acid-modified polyester alcohols (A1 to 7, 10, and 11) has an average number of blocked end groups in molecule of approximately 0.22 to 0.25, and an average number of acid-modified end groups of approximately 0.42 to 0.66.

<Preparation of Adhesive Samples 1 to 15>

Each of the partially acid-modified polyester alcohols (A-1) to (A-11) obtained in Preparative Examples was diluted with ethyl acetate to a concentration of 60%, to give an ethyl acetate solution.

According to the composition shown in Table 2 (values in Table: parts by mass), a phosphoric acid; a silane-coupling agent (γ-glycidoxypropyltrimethoxysilane); and twenty parts by mass (sample 1 to 3, 5 to 7, and 10 to 15), 6 parts by mass (Example 4), 10 parts by mass (sample 8), or 30 parts by mass (sample 9) of a diluted ethyl acetate solution (nonvolatile matter: 70 mass %) of a mixture of an isophorone diisocyanate/trimethylolpropane adduct (IPDI-TMP adduct) and a xylylene diisocyanate/trimethylolpropane adduct (XDI-TMP adduct) at a ratio of 1/1 (by mass) for the polyisocyanate (B), were added to 100 parts by mass of the ethyl acetate solution containing each of the partially acid-modified polyester alcohols (A-1) to (A-11) obtained in Preparative Examples 1 to 11, to give adhesive samples 1 to 15.

<Preparation of 3-Layer Composite Laminate>

Each adhesive sample prepared above was diluted to a nonvolatile matter concentration of 30% with ethyl acetate, and a 3-layer composite laminate of polyethylene terephthalate (PET) film (thickness: 12/μm)/adhesive layer (4.5 g/m²)/aluminum (AL) foil (thickness: 9 μm)/adhesive layer (4.5 g/m²)/casted polypropylene (CPP) film (thickness: 70 μm) was prepared by the method described below. Here, it is noted that, as to the polyethylene terephthalate film and the casted polypropylene film, the corona-discharged surface of the film was used for bonding.

First, the adhesive solution was coated on a polyethylene terephthalate (PET) film at normal temperature by using a coating machine, and, after evaporation of the solvent, the coated surface was bonded to the surface of an aluminum foil. Second, the adhesive solution was further coated similarly on the aluminum (AL) foil surface of the laminate, and, after vaporization of the solvent, the coated surface was bonded to a casted polypropylene (CPP) film, and left in an atmosphere at 40 degrees C. for 24 hours or in an atmosphere at 40 degrees C. for 96 hours, allowing curing (aging) of the adhesive layer.

(Lamination Strength Test 1)

The 3-layer composite laminate thus prepared was cut into a test piece of 15 mm×300 mm in size, and the lamination strength (N/15 mm) between the PET film and the AL foil and also between the AL foil and the CPP film was determined by a tensile tester in which the test piece was subjected to T-peel at a peeling rate of 30 mm/minute under a condition of a temperature of 20 degrees C. and a relative humidity of 65%.

(Lamination Strength Test 2)

A bag of 14 cm×18 cm in size was prepared with the 3-layer composite laminate, with the CPP film located inside, and a soup of 3% acetic acid/salad oil/ketchup=1/1/1 was filled therein, then subjecting to retort-processing at 135 degrees C. for 30 minutes.

After the retort processing, the bag was opened and a test piece of 15 mm×300 mm in size was cut off from the bag. The lamination strength (N/15 mm) of the test piece was measured under the same condition as that in the lamination strength test 1. The appearance of the test piece was also evaluated visually.

(Lamination Strength Test 3)

A bag of the 3-layer composite laminate was retort-processed in the same manner as that in the lamination strength test 2 and stored under an environment at 40 degrees C. for 14 days.

After the storage, the bag was opened, and the lamination strength between the AL foil and the CPP film was determined and the appearance was evaluated visually, in the same manner as that in lamination strength test 2.

The results obtained in the lamination strength tests 1 to 3 and in visual evaluation of the appearance are summarized in Table 3. In Table 3, ◯ indicates that the laminate is favorably free from lifting by visual evaluation; Δ indicates that there is slight whitening and lifting of the laminate; and X indicates that there are frequent whitening and lifting of the laminate. The storage test after retort processing is for examining the influence of the content on the lamination strength between the AL foil and the CPP film. The lamination strength between the PET film and the AL foil hardly varies during storage after retort processing because the AL foil functions as a kind of protective layer, and is thus not measured.

The results in Table 3 show distinctly that there is a greater difference in lamination strength between the curing periods of 96 hours and 24 hours in the adhesives of samples 12 and 13 prepared by using a partially acid-modified polyester alcohol not terminal-blocked with a monofunctional component, and that aging for 24 hours is not sufficient for complete curing. The results also show that, in the adhesives of samples 14 and 15, the adhesive layer is influenced from the content by storage at 40 degrees C. after retort processing and the lamination strength declined in both of aging for 24 hours and for 96 hours. In addition, comparison of the samples 12 and 13 shows that, without partial acid modification with anhydrotrimellitic acid, etc., the lamination strength declines during storage at 40 degrees C. after retort processing as the adhesive layer is influenced from the content even when the samples are aged for 96 hours for sufficient curing.

<Glass Transition Temperature of Adhesive Layer>

Each adhesive solution was applied and dried on a release-finished release sheet, kept in an atmosphere at 40 degrees C. for 24 hours or in an atmosphere at 40 degrees C. for 96 hours, allowing hardening (aging), to form an adhesive layer having a thickness of approximately 50 μm.

The adhesive layer was separated from the release sheet, and the glass transition temperature thereof was determined with a dynamic viscoelasticity tester. The programmed heating rate during measurement was 10 degrees C./minute. Results are summarized in Table 2.

TABLE 1

| Preparative Example | | | 1 | 2 | 3 | 4 | 5 | 6 |
|---|---|---|---|---|---|---|---|---|
| | | | Aaa-1 | Aaa-2 | Aaa-3 | Aaa-4 | Aaa-5 | Aaa-6 |
| Polyester | Hydroxyl | Ethylene glycol | 20.5 | 20.5 | 20.1 | 20.5 | 20.5 | 20.5 |
| alcohol | group | Neopentyl glycol | 45.8 | 45.8 | 22.5 | 45.8 | 45.8 | 45.8 |
| (Aaa) | component | 1,6-Hexanediol | 38.9 | 38.9 | 63.8 | 38.9 | 38.9 | 38.9 |
| | | Octyl alcohol | 0 | 0 | 0 | 0 | 1 | 1 |
| | Acid | Isophthalic acid | 61.4 | 61.4 | 60.4 | 61.4 | 61.4 | 61.4 |
| | component | Terephthalic acid | 61.4 | 61.4 | 60.4 | 61.4 | 61.4 | 61.4 |
| | | Sebacic acid | 50.5 | 50.5 | 49.6 | 50.5 | 50.5 | 50.5 |
| | | Benzoic acid | 1.2 | 1.2 | 1.2 | 1.2 | 0 | 0 |
| | Number-averaged molecular | | 11000 | 11000 | 11000 | 7200 | 11000 | 4800 |
| | weight | | | | | | | |
| | Hydroxyl value (mgKOH/g) | | 9.0 | 9.0 | 9.0 | 13.6 | 9.0 | 20.8 |
| | Average hydroxyl number in | | 1.76 | 1.76 | 1.76 | 1.75 | 1.76 | 1.78 |
| | molecule | | | | | | | |
| | | | Aa-1 | Aa-2 | Aa-3 | Aa-4 | Aa-5 | Aa-6 |
| Urethane- | Polyester alcohol | | Aaa-1 | | Aaa-3 | Aaa-4 | Aaa-5 | Aaa-6 |
| modified | (parts by mass) | | 300 | | 300 | 300 | 300 | 300 |
| polyester | Isophorone diisocyanate | | 3 | | 3 | 3 | 3 | 3 |
| alcohol (Aa) | (parts by mass) | | | | | | | |
| | Number-averaged molecular | | 12200 | | 12000 | 8100 | 12200 | 5100 |
| | weight | | | | | | | |
| | Hydroxyl value (mgKOH/g) | | 7.5 | | 7.7 | 12.0 | 8.1 | 19.5 |
| | Average hydroxyl number in | | 1.63 | | 1.65 | 1.73 | 1.76 | 1.77 |
| | molecule | | | | | | | |
| | | | A-1 | A-2 | A-3 | A-4 | A-5 | A-6 |
| Partially | Urethane-modified | | Aa-1 | Aaa-2 | Aa-3 | Aa-4 | Aa-5 | Aa-6 |
| acid-modified | polyester alcohol or | | 300 | 300 | 300 | 300 | 300 | 300 |
| polyester | polyester alcohol (parts | | | | | | | |
| alcohol(A) | by mass) | | | | | | | |
| | Ethylene glycol | | 4 | 4 | 4 | 6 | 4 | 4 |
| | bisanhydrotritate | | | | | | | |
| | (parts by mass) | | | | | | | |
| | Anhydrotrimellitic acid | | 2 | 2 | 2 | 3 | 2 | 2 |
| | (parts by mass) | | | | | | | |
| | Number-averaged molecular | | 12400 | 11400 | 12300 | 8500 | 12200 | 5200 |
| | weight | | | | | | | |
| | Hydroxyl value (mgKOH/g) | | 5.1 | 5.4 | 5.3 | 8.0 | 5.5 | 12.0 |
| | Average hydroxyl number in | | 1.13 | 1.10 | 1.16 | 1.21 | 1.20 | 1.11 |
| | molecule | | | | | | | |
| | Acid modification ratio (%) | | | | | | | |
| | | Based on polyester | 36.1 | 37.8 | 34.2 | 30.6 | 32.2 | 37.5 |
| | | alcohol(Aaa) | | | | | | |
| | | Based on urethane- | 30.9 | | 29.4 | 30.0 | 32.1 | 37.3 |
| | | modified polyester | | | | | | |
| | | alcohol (Aa) | | | | | | |

| | | | | | | |
|---|---|---|---|---|---|---|
| Nonvolatile matter after ethyl | 60 | 60 | 60 | 60 | 60 | 60 |
| acetate dilution (%) | | | | | | |

| Preparative Example | | | 7 | 8 | 9 | 10 | 11 |
|---|---|---|---|---|---|---|---|
| | | | Aaa-7 | Aaa-8 | Aaa-9 | Aaa-10 | Aaa-11 |
| Polyester | Hydroxyl | Ethylene glycol | 20.5 | 20.5 | 20.5 | 20.5 | 20.5 |
| alcohol | group | Neopentyl glycol | 45.8 | 45.8 | 45.8 | 45.8 | 45.8 |
| (Aaa) | component | 1,6-Hexanediol | 38.9 | 38.9 | 38.9 | 38.9 | 38.9 |
| | | Octyl alcohol | 1 | 0 | 0 | 0 | 0 |
| | Acid | Isophthalic acid | 61.4 | 61.4 | 61.4 | 61.4 | 61.4 |
| | component | Terephthalic acid | 61.4 | 61.4 | 61.4 | 61.4 | 61.4 |
| | | Sebacic acid | 50.5 | 50.5 | 50.5 | 50.5 | 50.5 |
| | | Benzoic acid | 0 | 0 | 0 | 1.2 | 1.2 |
| | Number-averaged molecular | | 14000 | 9000 | 9000 | 9000 | 9000 |
| | weight | | | | | | |
| | Hydroxyl value (mgKOH/g) | | 7.0 | 12.4 | 12.2 | 11.0 | 11.0 |
| | Average hydroxyl number in | | 1.75 | 1.99 | 1.96 | 1.76 | 1.76 |
| | molecule | | | | | | |
| | | | Aa-7 | Aa-8 | Aa-9 | Aa-10 | Aa-11 |
| Urethane- | Polyester alcohol | | Aaa-7 | Aaa-8 | Aaa-9 | Aaa-10 | Aaa-11 |
| modified | (parts by mass) | | 300 | 300 | 300 | 300 | 300 |
| polyester | Isophorone diisocyanate | | 5 | 3 | 3 | 3 | 3 |
| alcohol (Aa) | (parts by mass) | | | | | | |
| | Number-averaged molecular | | 18600 | 10000 | 10000 | 10000 | 10000 |
| | weight | | | | | | |
| | Hydroxyl value (mgKOH/g) | | 5.3 | 11.0 | 10.9 | 9.5 | 9.5 |
| | Average hydroxyl number in | | 1.76 | 1.96 | 1.94 | 1.69 | 1.69 |
| | molecule | | | | | | |
| | | | A-7 | A-8 | A-9 | A-10 | A-11 |
| Partially | Urethane-modified | | Aa-7 | Aa-8 | Aa-9 | Aa-10 | Aa-11 |
| acid-modified | polyester alcohol or | | 300 | 300 | 300 | 300 | 300 |
| polyester | polyester alcohol (parts | | | | | | |
| alcohol(A) | by mass) | | | | | | |
| | Ethylene glycol | | 4 | 4 | 0 | 6 | 0 |
| | bisanhydrotritate | | | | | | |
| | (parts by mass) | | | | | | |
| | Anhydrotrimellitic acid | | 2 | 2 | 0 | 0 | 6 |
| | (parts by mass) | | | | | | |
| | Number-averaged molecular | | 19200 | 11000 | 10000 | 11000 | 11000 |
| | weight | | | | | | |
| | Hydroxyl value (mgKOH/g) | | 3.5 | 6.9 | 10.9 | 6.5 | 5.8 |
| | Average hydroxyl number in | | 1.20 | 1.35 | 1.94 | 1.27 | 1.14 |
| | molecule | | | | | | |
| | Acid modification ratio (%) | | | | | | |
| | | Based on polyester | 31.4 | 32.0 | 0.7 | 27.8 | 35.6 |
| | | alcohol(Aaa) | | | | | |
| | | Based on urethane- | 31.8 | 31.0 | 0.0 | 24.7 | 32.8 |
| | | modified polyester | | | | | |
| | | alcohol (Aa) | | | | | |

| | | | | | |
|---|---|---|---|---|---|
| Nonvolatile matter after ethyl | 60 | 60 | 60 | 60 | 60 |
| acetate dilution (%) | | | | | |

TABLE 2

| | | Adhesive sample | | | | | | | |
|---|---|---|---|---|---|---|---|---|---|
| | | 1 | 2 | 3 | 4 | 5 | 6 | 7 | 8 |
| Partially acid- | A-1: Preparative Example 1 | 100 | | | | | | | 100 |
| modified polyester | A-2: Preparative Example 2 | | 100 | | | | | | |
| alcohol (A) | A-3: Preparative Example 3 | | | 100 | | | | | |
| solution (parts | A-4: Preparative Example 4 | | | | 100 | | | | |
| by mass) | A-5: Preparative Example 5 | | | | | 100 | | | |
| | A-6: Preparative Example 6 | | | | | | 100 | | |
| | A-7: Preparative Example 7 | | | | | | | 100 | |
| | A-8: Preparative Example 8 | | | | | | | | |
| | A-9: Preparative Example 9 | | | | | | | | |
| | A-10: Preparative Example 10 | | | | | | | | |
| | A-11: Preparative Example 11 | | | | | | | | |

| | | | | | | | | |
|---|---|---|---|---|---|---|---|---|
| Number of OH groups in 60 parts by mass of | 0.0055 | 0.0058 | 0.0057 | 0.0085 | 0.006 | 0.0128 | 0.0038 | 0.0055 |
| partially acid-modified polyester alcohol (A) | | | | | | | | |
| Phosphoric acid (parts by mass) | 0.04 | 0.04 | 0.04 | 0.04 | 0.04 | 0.04 | 0.04 | 0.04 |
| Silane-coupling agent (parts by mass) | 0.3 | 0.3 | 0.3 | 0.3 | 0.3 | 0.3 | 0.3 | 0.3 |
| Polyisocyanate (B) solution (parts by mass) | 20 | 20 | 20 | 6 | 20 | 20 | 20 | 10 |
| Number of NCO groups in polyisocyanate (B) | 0.056 | 0.056 | 0.056 | 0.017 | 0.056 | 0.056 | 0.056 | 0.028 |
| NCO groups in IPDI-TMP | 0.026 | 0.026 | 0.026 | 0.008 | 0.026 | 0.026 | 0.026 | 0.013 |
| NCO groups in XDI-TMP | 0.030 | 0.030 | 0.030 | 0.009 | 0.030 | 0.030 | 0.030 | 0.015 |
| NCO/OH | 10.303 | 9.731 | 9.956 | 1.979 | 9.546 | 4.399 | 15.023 | 5.152 |
| Glass transition temperature (Tg) (° C.) | 10 | 2 | 18 | 10 | 10 | 10 | 10 | 10 |

| | | Adhesive sample | | | | | | |
|---|---|---|---|---|---|---|---|---|
| | | 9 | 10 | 11 | 12 | 13 | 14 | 15 |
| Partially acid- | A-1: Preparative Example 1 | 100 | 100 | 100 | | | | |
| modified polyester | A-2: Preparative Example 2 | | | | | | | |
| alcohol (A) | A-3: Preparative Example 3 | | | | | | | |
| solution (parts | A-4: Preparative Example 4 | | | | | | | |
| by mass) | A-5: Preparative Example 5 | | | | | | | |
| | A-6: Preparative Example 6 | | | | | | | |
| | A-7: Preparative Example 7 | | | | | | | |
| | A-8: Preparative Example 8 | | | | 100 | | | |
| | A-9: Preparative Example 9 | | | | | 100 | | |
| | A-10: Preparative Example 10 | | | | | | 100 | |
| | A-11: Preparative Example 11 | | | | | | | 100 |

| | | | | | | | |
|---|---|---|---|---|---|---|---|
| Number of OH groups in 60 parts by mass of | 0.0055 | 0.0055 | 0.0055 | 0.0074 | 0.0116 | 0.0069 | 0.0062 |
| partially acid-modified polyester alcohol (A) | | | | | | | |
| Phosphoric acid (parts by mass) | 0.04 | 0.04 | | 0.04 | 0.04 | 0.04 | 0.04 |
| Silane-coupling agent (parts by mass) | 0.3 | | 0.3 | 0.3 | 0.3 | 0.3 | 0.3 |
| Polyisocyanate (B) solution (parts by mass) | 30 | 20 | 20 | 20 | 20 | 20 | 20 |
| Number of NCO groups in polyisocyanate (B) | 0.085 | 0.056 | 0.056 | 0.056 | 0.056 | 0.056 | 0.056 |
| NCO groups in IPDI-TMP | 0.039 | 0.026 | 0.026 | 0.026 | 0.026 | 0.026 | 0.026 |
| NCO groups in XDI-TMP | 0.045 | 0.030 | 0.030 | 0.030 | 0.030 | 0.030 | 0.030 |
| NCO/OH | 15.455 | 10.303 | 10.303 | 7.651 | 4.840 | 8.132 | 9.060 |
| Glass transition temperature (Tg) (° C.) | 10 | 10 | 10 | 14 | 10 | 10 | 10 |

Silane-coupling agent: γ-glycidoxypropyltrimethoxysilane
Polyisocyanate (B): diluted ethyl acetate solution (nonvolatile matter: 70 mass %) of a mixture of isophorone diisocyanate/trimethylolpropane adduct (IPDI-TMP adduct) and xylylene diisocyanate/trimethylolpropane adduct (XDI-TMP adduct) at a ratio of 1/1 (by mass)

TABLE 3

| | | | Adhesive sample | | | | | | | |
|---|---|---|---|---|---|---|---|---|---|---|
| | | | 1 | 2 | 3 | 4 | 5 | 6 | 7 | 8 |
| Aging at 40° C. | Before retort | PET/AL | 4.2 | 4.8 | 4 | 4.2 | 4.2 | 4.8 | 4.2 | 4 |
| for 24 hours | processing | AL/CPP | 10 | 11 | 8.8 | 10.2 | 10 | 10 | 9 | 9.8 |
| | After retort | PET/AL | ◯4.0 | ◯4.0 | ◯4.0 | ◯4.0 | ◯4.0 | ◯4.0 | ◯4.0 | ◯4.0 |
| | processing | AL/CPP | ◯7.2 | ◯6.4 | ◯5.0 | ◯7.0 | ◯7.2 | ◯6.8 | ◯6.4 | ◯5.0 |
| | Storage at | AL/CPP | ◯6.8 | ◯5.0 | ◯6.2 | ◯6.4 | ◯7.0 | ◯6.6 | ◯6.2 | ◯5.2 |
| | 40° C. for | | | | | | | | | |
| | 14 days | | | | | | | | | |
| | after retort | | | | | | | | | |
| | processing | | | | | | | | | |
| Aging at 40° C. | Before retort | PET/AL | 4.4 | 4.8 | 4.4 | 4.4 | 4.2 | 4.8 | 4.2 | 4.2 |
| for 96 hours | processing | AL/CPP | 10.2 | 11 | 9.4 | 10.2 | 10 | 10 | 9.2 | 10 |
| | After retort | PET/AL | ◯4.0 | ◯4.0 | ◯4.4 | ◯4.0 | ◯4.0 | ◯4.2 | ◯4.0 | ◯4.0 |
| | processing | AL/CPP | ◯8.2 | ◯6.6 | ◯6.4 | ◯7.2 | ◯7.4 | ◯7.2 | ◯6.8 | ◯6.0 |
| | Storage at | AL/CPP | ◯7.0 | ◯5.6 | ◯6.4 | ◯6.6 | ◯7.0 | ◯6.8 | ◯6.6 | ◯5.8 |
| | 40° C. for | | | | | | | | | |
| | 14 days | | | | | | | | | |
| | after retort | | | | | | | | | |
| | processing | | | | | | | | | |

| | | | Adhesive sample | | | | | | |
|---|---|---|---|---|---|---|---|---|---|
| | | | 9 | 10 | 11 | 12 | 13 | 14 | 15 |
| Aging at 40° C. | Before retort | PET/AL | 4.2 | 4 | 4.2 | 4.2 | 4 | 4.2 | 4.2 |
| for 24 hours | processing | AL/CPP | 10.2 | 9.2 | 10.2 | 8 | 8.8 | 10 | 10 |
| | After retort | PET/AL | ◯4.0 | ◯4.0 | ◯4.0 | ◯4.0 | ◯4.0 | ◯4.0 | ◯4.0 |
| | processing | AL/CPP | ◯7.0 | ◯7.0 | ◯7.0 | Δ4.2 | Δ4.0 | ◯7.2 | ◯7.2 |
| | Storage at | AL/CPP | ◯6.4 | ◯6.0 | ◯6.4 | X4.4 | X4.4 | Δ4.8 | Δ4.4 |
| | 40° C. for | | | | | | | | |
| | 14 days | | | | | | | | |
| | after retort | | | | | | | | |
| | processing | | | | | | | | |
| Aging at 40° C. | Before retort | PET/AL | 4.2 | 3.8 | 4.2 | 4.4 | 4.2 | 4.4 | 4.4 |
| for 96 hours | processing | AL/CPP | 10.2 | 10 | 10.2 | 9.8 | 10 | 10.2 | 10.2 |
| | After retort | PET/AL | ◯4.0 | ◯4.0 | ◯4.0 | ◯4.0 | ◯4.0 | ◯4.0 | ◯4.0 |
| | processing | AL/CPP | ◯7.6 | ◯7.6 | ◯7.6 | ◯6.8 | ◯7.0 | ◯8.2 | ◯8.2 |
| | Storage at | AL/CPP | ◯6.6 | ◯6.6 | ◯5.6 | ◯6.4 | ◯6.4 | Δ5.0 | Δ4.8 |
| | 40° C. for | | | | | | | | |
| | 14 days | | | | | | | | |
| | after retort | | | | | | | | |
| | processing | | | | | | | | |

### INDUSTRIAL APPLICABILITY

According to the present invention, it is possible to provide an adhesive that the period necessary for curing reaction (aging period) is shorter and it is also possible, using the same, to manufacture a laminate for packaging that is sufficiently resistant to retort processing and that deterioration in adhesiveness is small during long-term storage, efficiently with aging for a shortened period.

The present invention is not limited to the embodiments described above, and it would be obvious for those skilled in the art that various modifications are possible within the scope of the claims of the present invention.

1. An adhesive, comprising:
a partially acid-modified polyester alcohol composition (A), prepared by esterifying a part of the hydroxyl groups in a polyester alcohol composition (AA) with anhydrotrimellitic acid and an anhydrotrimellitate ester at an anhydrotrimellitic acid/anhydrotrimellitate ester ratio of 10/90 to 70/30 (by mass), said polyester alcohol (AA) comprising a condensation product of a polycarboxylic acid and a polyvalent alcohol containing at least one of a monocarboxylic acid and a monovalent alcohol; and
a polyisocyanate (B).

2. The adhesive according to claim 1, wherein the partially acid-modified polyester alcohol composition (A) has a hydroxyl value of 3 to 15 mgKOH/g and a number-average molecular weight of 4000 to 20000.

3. The adhesive according to claim 1, wherein the polycarboxylic acid and the polyvalent alcohol contain the monocarboxylic acid at a ratio of 10 mol % or less with respect to the total molar amount of the polycarboxylic acid and the monocarboxylic acid, or the monovalent alcohol at a ratio of 10 mol % or less with respect to the total molar amount of the polyvalent alcohol and the monovalent alcohol.

4. The adhesive according to claim 1, wherein the anhydrotrimellitate ester is ethylene glycol bisanhydrotrimellitate represented by the following formula (I).

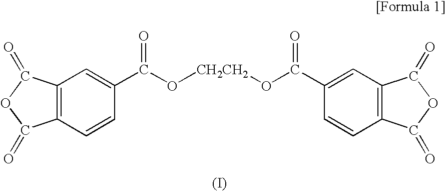

5. The adhesive according to claim 1, wherein the ratio of said part of the hydroxyl groups esterified with anhydrotrimellitic acid and the anhydrotrimellitate ester in the partially acid-modified polyester alcohol composition (A) is 20 to 90% with respect to the hydroxyl groups in the polyester alcohol composition (AA).

6. The adhesive according to claim 1, wherein, in the partially acid-modified polyester alcohol composition (A), another part of the hydroxyl groups of the polyester alcohol composition (AA) are urethane-modified by reaction with a polyisocyanate.

7. The adhesive according to one claim 1, wherein the average number of hydroxyl groups in the molecule of the partially acid-modified polyester alcohol composition (A) is 1.005 to 1.6.

8. The adhesive according to claim 1, containing the polyisocyanate (B) in an amount of 5 to 50 parts by mass with respect to 100 parts by mass of the partially acid-modified polyester alcohol composition (A).

9. An adhesive, comprising:
a polyester alcohol composition (A) containing hydroxyl groups, ester groups of a monocarboxylic acid or a monovalent alcohol esterified with a hydroxyl or carboxyl group, first acyloxy groups formed in reaction of a hydroxyl group with anhydrotrimellitic acid, and second acyloxy groups formed in reaction of a hydroxyl group with an anhydrotrimellitate ester, wherein the ratio of the first acyloxy groups to the second acyloxy groups corresponds to such a molar ratio of anhydrotrimellitic acid to the anhydrotrimellitate ester that the ratio by mass of anhydrotrimellitic acid to the anhydrotrimellitate ester is 10/90 to 70/30; and
a polyisocyanate (B).

10. The adhesive according to claim 9, wherein the polyester alcohol composition (A) has urethane bonds formed by reaction of a polyisocyanate with the hydroxyl groups.

11. The adhesive according to claim 9, wherein the polyester alcohol composition (A) has a hydroxyl value of 3 to 15 mgKOH/g and a number-average molecular weight in the range of 4000 to 20000.

12. The adhesive according to claim 1, further comprising at least one of a phosphorus oxyacid or the derivatives thereof and a silane-coupling agent.

13. The adhesive according to claim 1, further comprising an organic solvent, for giving an organic solvent solution, having a nonvolatile matter content of 40% or less.

14. A laminate for packaging, comprising a plurality of sheet-shaped base materials laminated with the adhesive according to claim 1.

15. The adhesive according to claim 9, further comprising at least one of a phosphorus oxyacid or the derivatives thereof and a silane-coupling agent.

16. The adhesive according to claim 9, further comprising an organic solvent, for giving an organic solvent solution, having a nonvolatile matter content of 40% or less.

17. A laminate for packaging, comprising a plurality of sheet-shaped base materials laminated with the adhesive according to claim 9.

18. The adhesive according to claim 1, wherein the ratio of said part of the hydroxyl groups esterified with anhydrotrimellitic acid and the anhydrotrimellitate ester in the partially acid-modified polyester alcohol composition (A) is 20 to 90% with respect to the hydroxyl groups in the polyester alcohol composition (AA), and another part of the hydroxyl groups of the polyester alcohol composition (AA) are urethane-modified by reaction with a polyisocyanate;
the average number of hydroxyl groups in the molecule of the partially acid-modified polyester alcohol composition (A) is 1.005 to 1.6, and the partially acid-modified polyester alcohol composition (A) has a hydroxyl value of 3 to 15 mgKOH/g and a number-average molecular weight of 4000 to 20000;
the polycarboxylic acid and the polyvalent alcohol contain the monocarboxylic acid at a ratio of 10 mol % or less with respect to the total molar amount of the polycarboxylic acid and the monocarboxylic acid, or the monovalent alcohol at a ratio of 10 mol % or less with respect to the total molar amount of the polyvalent alcohol and the monovalent alcohol;
the polyisocyanate (B) is contained in an amount of 5 to 50 parts by mass with respect to 100 parts by mass of the partially acid-modified polyester alcohol composition (A); and
the anhydrotrimellitate ester is ethylene glycol bisanhydrotrimellitate represented by the following formula (I).

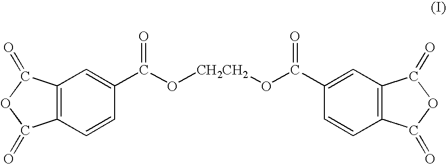

19. The adhesive according to claim 9, wherein the polyester alcohol composition (A) has urethane bonds formed by the reaction of a polyisocyanate with the hydroxyl groups, and the polyester alcohol composition (A) has a hydroxyl value of 3 to 15 mgKOH/g and a number-average molecular weight in the range of 4000 to 20000.
